(19) United States
(12) Patent Application Publication
(10) Pub. No.: US 2023/0155903 A1
(43) Pub. Date: May 18, 2023

(54) SYSTEM AND METHOD OF SOCIAL CONTROL-AND-USE OF IoT DEVICE, CONTROL SERVER SUPPORTING SOCIAL CONTROL-AND-USE OF IoT DEVICE AND MOBILE DEVICE USED FOR SOCIAL CONTROL-AND-USE OF IoT DEVICE

(71) Applicant: Korea Advanced Institute of Science and Technology, Daejeon (KR)

(72) Inventors: Junehwa Song, Daejeon (KR); Wonjung Kim, Daejeon (KR); Seungchul Lee, Daejeon (KR); Youngjae Chang, Daejeon (KR); Taegyeong Lee, Daejeon (KR); Inseok Hwang, Pohang (KR)

(73) Assignee: Korea Advanced Institute of Science and Technology, Daejeon (KR)

(21) Appl. No.: 17/562,137

(22) Filed: Dec. 27, 2021

(30) Foreign Application Priority Data
Nov. 12, 2021 (KR) 10-2021-0155437

(51) Int. Cl. H04L 43/06; G16Y 30/00; G07C 13/00; G16Y 20/10

(52) U.S. Cl. CPC H04L 43/06; G16Y 30/00; G07C 13/00; G16Y 20/10

(57) ABSTRACT

Disclosed herein is a system for social control and use of an Internet of Things (IoT) device, comprising an actuator, one or more mobile devices, and a control server. The actuator is arranged or disposed in a public or common space. The one or more mobile devices comprises a social control user interface (UI), which includes a voting function. The control server comprises a preference aggregation engine for deriving a consensus by aggregating vote(d) values from the one or more mobile devices, and a device control command generating unit for generating a device control command based on the consensus. Other embodiments are described and shown.

### BACKGROUND

### 1. Field of the Invention

The present disclosure relates social control and use of IoT device, and in particular, to a system and method of social control-and-use of IoT device, a control server supporting social control-and-use of IoT device, and a mobile device used for social control-and-use of IoT device.

### 2. Description of Related Art

There must have been times when you were shivering in the cold on a sweltering summer day on a long-distance bus, or your child was sniffing because of the cold air blowing from the air conditioner, and you were frustrated because you could not control the air conditioner. There must have been times when you were annoyed by the otherwise trendy, upbeat music from the cafe, because it sounded harsh to your ears. There may have been times when you had to endure the inconvenience, thinking that only you felt that way. In reality, there are times when you, nor anyone else can act to change the situation although everyone is suffering. These circumstances can sometimes cause conflict and division among people. “It's too hot. Let's turn on the air conditioning.” “It's too cold. Let's turn it off.” Such conflict over air conditioning is not rare or uncommon in spaces such as the school classroom.

Public space or premises have public actuators, such as HVAC (heating, ventilation & air conditioning), lighting fixtures, speakers or streaming TV channels. However, most of the public actuators allow little or no control by a visitor, thereby limiting the usability, usefulness and fairness among visitors.

Also, for someone among the visitors speaks of his/her preferences, or control the operation of the actuator, social or societal restrictions can be high. While the social control and use of Internet of Things (IoT) devices have great potential and implications, they are ensued by high complexity and scale, and this is a new research direction that has not yet been properly studied.

### BRIEF SUMMARY

To solve such problems as above, an object of the present disclosure is to provide a system for social control and use of IoT devices.

Another object of the present disclosure is to provide a method of social control and use of IoT devices.

Another object of the present disclosure is to provide a control server supporting social control and use of IoT devices.

Another object of the present disclosure is to provide a mobile device used for social control and use of IoT devices.

According to an embodiment of the present disclosure, a system of social control and use of Internet-of-Things device may comprise an actuator arranged or disposed in a public or common space; one or more mobile devices, comprising a social control user interface, which includes a voting function; and a control server, comprising a preference aggregation engine, deriving a consensus by aggregating vote values from the one or more mobile devices, and a device control command generation unit, generating a device control command based on the consensus.

According to an embodiment, the control server may further comprise an entity manager unit for managing the Internet-of-Things device operated by the actuator, the common space, and one or more participants.

According to an embodiment, the entity manager may output information of the common space, information of the Internet of Things device, and information of preference distribution of the one or more participants to the one or more mobile devices; and the one or more mobile devices may further comprise a schema-based control user interface generation unit, generating the social control user interface based on the information of the common space, the information of the Internet of Things device, and the information of the preference distribution of the participants.

According to an embodiment, the one or more mobile devices may further comprise a device discovery unit, using a distance measuring technology, including at least one of Bluetooth, BLE (Bluetooth Low Energy), Wi-Fi, UWB (Ultra-Wideband), LIDAR (light detection and ranging), and SONAR (sound navigation and ranging), and notifying that a visitor exists or not exist within an area of influence of the actuator.

According to an embodiment the control server may further comprise an administration tool, the administration tool, comprising a policy authoring tool, the policy authoring tool, setting aggregation policy and authorization policy, and outputting the aggregation policy to a preference aggregation engine and outputting the authorization policy to the influence-aware-based authorization unit.

According to an embodiment, the control server may further comprise an influence-aware-based authorization unit, determining whether the visitor is the participant based on influence of the Internet-of-Things device, and granting authority for the social control and use of the Internet-of-Things device to the participant.

According to an embodiment, the influence-aware-based authorization unit may determine the area of influence of the actuator through a room-level indoor positioning technology based on space division or layout of the common space.

According to an embodiment, the influence-aware-based authorization unit may receive signal of the actuator through the one or more devices and determine whether the one or more devices is within the area of influence of the actuator.

According to an embodiment, when the actuator is a speaker, the one or more mobile devices may record audio in surrounding environment, extract a first audio feature, and transmit the first audio feature to the control server; and the influence-aware-based authorization unit of the control server may extract a second audio feature from source audio, calculate a temporal correlation distance between the first audio feature and the second audio feature, and determine whether the one or more devices is within the area of influence of the actuator based on the temporal correlation distance.

According to another embodiment, the influence-aware-based authorization unit may synchronize time offset of the first audio feature and the second audio feature.

According to an embodiment, the influence-aware-based authorization unit may filter the temporal correlation distance with signal strength of the source audio.

According to an embodiment, the preference aggregation engine may use a utility function, the utility function, receiving a user preference for a state of the actuator as input and returning quantified satisfaction between 0 (“unhappy”) and 1 (“happy”).

According to an embodiment, the when variables of the actuator has nominal scale, the utility function may be

$$U ( {p}_{i} , s ) = \{ \begin{matrix}1. & if s ∈ {p}_{i} \\ 0. & if s ∉ {p}_{i}\end{matrix} \begin{matrix}U : utility function \\ {p}_{i} : selected options \\ s : state of an actuator\end{matrix}$$

where pᵢ is option selected by a participant i, and s is the state of the actuator.

According to an embodiment, when the variables of the actuator have ordinal scale, the satisfaction may degrade when a distance between the state of the actuator and the user preference increases.

According to an embodiment, the satisfaction may be determined based on L1 or L2 distance (explained later).

According to an embodiment, the preference aggregation engine may determine the state of the actuator as the state which maximizes total utility of the one or more participants in a first mode.

According to an embodiment, when in the first mode, a next state of the actuator may be determined by formula

$${s}_{next} = {arg max}_{s ∈ S} \vert {\sum }_{i ∈ I} U ( {p}_{i} , s ) \vert \begin{matrix}I : set of participants \\ {s}_{next} : next actuator state \\ S : set of state variable options\end{matrix}$$

where I is a set of the participants, sₙₑₓₜ is the next state of the actuator, and S is a set of variable options of the state of the actuator; U is a utility function, pi is option selected by the participant i, and s is the state of the actuator.

According to an embodiment, the preference aggregation engine may determine the state of the actuator by distributing utility over time in a second mode and allowing the participants to receive the utility in turn.

According to an embodiment, in the second mode, the next state of the actuator may be determined as the state in which a sum of past cumulative satisfaction and future expected satisfaction is maximum for the participant having a minimum sum of the cumulative past satisfaction and the estimated future satisfaction.

According to an embodiment, in the second mode, the next state of the actuator is determined by formulas

$${U}_{prev} = {\sum }_{t = τ - ω}^{τ - 1} U ( {p}_{i , t} , {s}_{t} ) , {U}_{exp} = {\sum }_{t = τ}^{τ + δ ( s )} U ( {p}_{i , t} , s ) \\ {s}_{next} = {arg max}_{s ∈ S} {min}_{i ∈ t} [ {U}_{prev} + {U}_{exp} ]$$

where Uₚᵣₑᵥ is the past cumulative satisfaction, Uₑₓₚ is future estimated satisfaction; τ is current time; ω is time window for calculating the past cumulative satisfaction, δ(s) is expected duration that the state s holds or is expected to continue in the future; p_{i,t} is option selected at time t by participant i; and sₜ is state of the actuator at the time t.

According to an embodiment, the preference aggregation engine may be configured to apply state priority to a particular state among a plurality of states in a third mode.

According to an embodiment, in the third mode, the preference aggregation engine may be configured to prevent oscillations by temporarily assigning high priority to a current state of the actuator.

According to an embodiment, in the third mode, the preference aggregation engine may determine the state of the actuator based on priority among states specified by a manger of the common space.

According to an embodiment, the preference aggregation engine may determine a state of the actuator that maximizes total of utility of participants, in a first mode; the preference aggregation engine may determine the state of the actuator by distributing the utility over time in a second mode to allow the participants to receive the utility in turn, in a second mode; the preference aggregation engine may determine the state of the actuator by applying state priority to a particular state among a plurality of states, in a third mode; and the preference aggregation engine may apply the first mode, the second mode, and the third mode sequentially according to predetermined mode priority.

According to an embodiment, the preference aggregation engine may determine the state of the actuator based on a weighted sum of the first mode, the second mode, and the third mode.

According to an embodiment, the control server may further comprise a participant discovery unit, searching for the one or more mobile devices of visitors within an area of influence of the actuator; and an influence-aware-based authorization unit, determining whether the visitor are participant based on physical states of the visitors and the area of influence of the Internet-of-Things device, and granting authority to the social control and use of the Internet-of-Things device to the participants.

According to an embodiment, a method of social control and use of Internet-of-Things device may comprise: transmitting to a control server, a voted value based on a social control user interface included in one or more mobile devices; aggregating in the control server, the voted values from the one or more mobile devices and deriving a consensus on operation of an actuator located in a common space; generating device control command based on the consensus; and outputting the device control command to the actuator.

According to an embodiment, in a device connectivity layer, connection between/among the one or more mobile devices, control server, and the actuator may be provided.

According to an embodiment, in a participant discovery and authorization layer, participants near the common space may be identified, and authority of the social control and use of the Internet-of-Things device may be granted to the participants.

According to an embodiment, in a social interaction layer, a social control user interface may be provided in the one or more mobile devices of the participants granted authority, and the voted value from the social control user interface may be received.

According to an embodiment, in an aggregation and consensus layer, a plurality of preferences collected from the participants in the social control interaction layer may be collected, and the consensus may be derived on the plurality of the preferences.

According to an embodiment, in the aggregation and consensus layer, control of the Internet-of-Things device may be performed based on the consensus derived.

According to an embodiment, in the participant discovery and authentication layer, the authority of the social control and use of the Internet-of-Things device may be granted to the one or more mobile devices of the participants within an area of influence of the actuator, among the participants near the common space.

According to an embodiment, in the participant discovery and authentication layer, the authority of the social control and use may be updated in real-time when the participants within the area of influence of the actuator move out of the area of influence, or whether a new participant moves into the area of influence of the actuator.

According to an embodiment, when the authority of the social control and use is updated in the participant discovery and authentication layer, in the social control interaction layer, the social control user interface may be provided to the mobile device of the changed participant in real time, and in the aggregation and consensus layer, new consensus on updated preference may be derived.

According to an embodiment, a control server system supporting social control and use of Internet-of-Things device may comprise: an influence-based authorizer, determining whether one or more visitors is a participant based on physical state of the visitor in a common space and area of influence of the Internet-of-Things device, and granting the participant authority to control and use the Internet-of-Things device; an entity manager, managing the Internet-of-Things device, the common space, and the participant; a preference aggregation engine, deriving a consensus by aggregating voted values from the participant's mobile device; and a device control command generator, generating a device control command based on the consensus.

According to an embodiment, a mobile device used for social control and use of Internet-of-Things device may comprise the device discovery unit, notifying the control server of proximity to the actuator in the common space; the schema-based control user interface generation unit, generating the social control user interface based on information of the common space and Internet-of-Things device received from the control server; and the social control user interface, including a voting function for voting a preference for controlling the actuator.

According to an embodiment, the social control user interface may comprise the voting function, preference distribution visualization function and chat function.

According to an embodiment, the schema-based control user interface generation unit may provide a state description, including summary information about the state of the actuator to help the participant determine a preference.

According to the embodiments of the system and method for social control and use of an Internet-of-Things device according to the present invention, the control server supporting the social control and use of Interne-of-Things devices, and the mobile device used therefor, the actuators in a public or common space may be appropriately controlled by a plurality of visitors. Supporting the visitors to instantly participate in a democratic collective control, the actuators that are otherwise controlled exclusively in public spaces may be converted into true public actuators.

Also, numerous off-the-shelf actuators may be integrated without modifying their implementation methods.

### BRIEF DESCRIPTION OF THE DRAWINGS

FIG. 1 shows a concept diagram of a method of social control and use of IoT device, according to an embodiment.

FIG. 2 shows an illustrative diagram of a method of social control and use of IoT device, illustrating the method as 5-layers, according to an embodiment.

FIG. 3 shows a concept diagram of a system of social control and use of IoT device, according to an embodiment.

FIG. 4 shows a block diagram of the system of social control and use of IoT device of FIG. 3.

FIG. 5 shows a block diagram of the system of social control and use of IoT device of FIG. 4.

FIG. 6 shows a concept diagram of operation of the influence-based or influence-aware authorizer of FIG. 5.

FIG. 7, FIG. 8, and FIG. 9 show execution screens of an application (app) of the mobile apparatus or device of FIG. 4, according to various embodiments.

FIG. 10 shows a detailed block diagram of a system of social control-and-use of IoT device, according to an embodiment.

### DETAILED DESCRIPTION

Hereinafter, various embodiments of the present invention are shown and described. Particular embodiments are exemplified herein and are used to describe and convey to a person skilled in the art, particular structural, configurational and/or functional, operational aspects of the invention. The present invention may be altered/modified and embodied in various other forms, and thus, is not limited to any of the embodiments set forth.

The present invention should be interpreted to include all alterations/modifications, substitutes, and equivalents that are within the spirit and technical scope of the present invention.

Terms such as “first,” “second,” “third,” etc. herein may be used to describe various elements and/or parts but the elements and/or parts should not be limited by these terms. These terms are used only to distinguish one element and/or part from another. For instance, a first element may be termed a second element and vice versa, without departing from the spirit and scope of the present invention.

When one element is described as being “joined” or “connected” etc. to another element, the one element may be interpreted as “joined” or “connected” to that another element directly or indirectly via a third element, unless the language clearly specifies. Likewise, such language as “between,” “immediately between,” “neighboring,” “directly neighboring” etc. should be interpreted as such.

Terminology used herein is for the purpose of describing particular exemplary embodiments only and is not intended to limit the present invention. As used herein, singular forms (e.g., “a,” “an”) include the plural forms as well, unless the context clearly indicates otherwise. The language “comprises,” “comprising,” “including,” “having,” etc. are intended to indicate the presence of described features, numbers, steps, operations, elements, and/or components, and should not be interpreted as precluding the presence or addition of one or more of other features, numbers, steps, operations, elements, and/or components, and/or grouping thereof.

Unless otherwise defined, all terms (including technical and scientific terms) used herein have same meaning as those commonly understood by a person with ordinary skill in the art to which this invention pertains. Terms, such as those defined in commonly used dictionaries, should be interpreted as having meaning that is consistent with their meaning in the context of the relevant art and should not be interpreted in an idealized or overly formal sense unless expressly so defined herein.

Further, when embodiment may be implemented differently, function or operation which is specified in a given block may occur in different sequence than as specified in flowcharts. For example, two continuous blocks may actually be performed substantially simultaneously, and the blocks may be performed in reverse according to related functions or operation.

Hereafter, various embodiments of the present invention are described in more detail with reference to the accompanying drawings. Same reference numerals are used for the same elements in the drawings, and duplicate descriptions are omitted for the same elements or features.

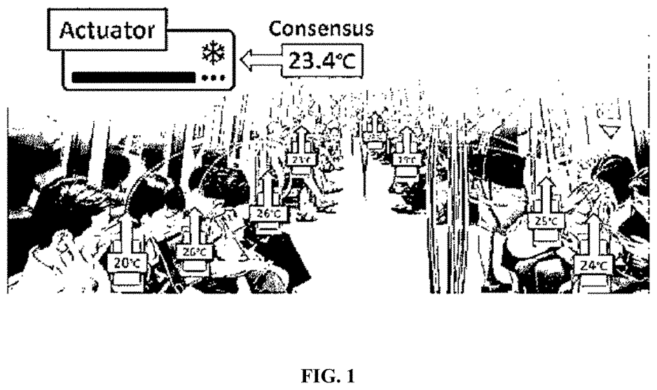

FIG. 1 shows a concept (diagram) of a method of social control and use of IoT device, according to an embodiment.

Referring to FIG. 1, public or common space (i.e., subway as shown) is the basic in modern city life. Such sharing means and culture may be an indicator for the quality of life in the city. For example, buses and restaurants must provide comfort and satisfaction to the people therein. Also, buses and restaurants must show hospitality in caring for the weak or vulnerable and meeting their special needs. However, devices and apparatuses (e.g., air conditioning and heating actuators) in buses and restaurants mostly operate in closed, exclusive manners.

Due to the proprietary nature and exclusive characteristics of activation and control interface of the actuator, there are restrictions on the comprehensive sharing of the common space. Traditional forms of interfaces generally consist of buttons, dials and panels with on-off, up-down or sliding functions. These structures can only be controlled by a person who has been granted access, and there is inadequacy in flexibly reflecting various demands of multiple people. Therefore, the actuators that contain the operating details of the space (i.e., public or common actuators) are exclusively controlled while the space itself is being shared.

Some actuators that support IoT allow remote control via mobile app, but such control is still limited to exclusive use by the actuator owner through authentication or physical pairing, etc. Even with the actuators that support IoT, the philosophy of one-to-one control remains the same, and the concept of social, collective control by the masses does not exist. Consequently, it is important to find new ways to open the actuator's activation and control mode to multiple people (who visit the common space) and to democratically control the actuator.

For this, the present disclosure presents (the potential of) social control and use of IoT device. Referring back to FIG. 1, people who boarded the subway, each has a different preference value for the air conditioning temperature setting, and in the disclosed (exemplary embodiments of) method of social control and use of IoT device, a control server may collect each person's preference values through the visitor's mobile device and derive consensus (an agreement on e.g., 23.4 degree) for the air conditioning setting. The control server may be configured to output a control signal to actuator for the air conditioning based on the consensus.

In the present embodiment, first provided is a new architecture for social control and use of IoT device. The architecture provides viewpoints and insights on a systematic management of large-scale, very complex problems.

In the embodiment, presented is a system developed to share (IoT supported) actuators in a common space based on the architecture.

Developing a system for the social control and use is a complex problem. The system is associated with 3 already complex factors/entities: users, devices and spaces. The system must consider heterogeneity and complex potential interactions of the entities.

Public or common spaces further complicate the situation. Common spaces inherently have uncertainties. Visitors to common spaces may, at any time at their own will, freely enter a space or exit into another space. It is not possible or utterly difficult to predict who the visitors are and when they will visit. Also, the visitors are strangers to each other. Similarly, the visitors face actuator devices in unfavorable ways. For example, the visitors do not know what actuator devices they will encounter in the space. Also, it is unclear who among the visitors are eligible to participate in the control of the actuator devices. Further, interaction between/among the visitors is almost impossible. These complexities and uncertainties make the adoption of simple and ordinary strategies for designing the system difficult.

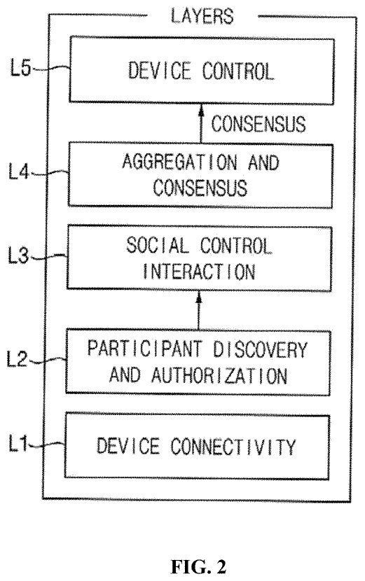

FIG. 2 shows an illustrative diagram of a method of social control and use of IoT device, illustrating the method as 5 (five)-layers, according to an embodiment.

Referencing FIG. 2, the embodiment of the architecture for social control and use of IoT device may provide a basis for carrying out and refining the challenge and effort for the design of the system. The embodiment of the architecture for social control and use is developed with 5-layers through in-depth application of a principle of separation of concerns.

1st layer (L1) is device connectivity layer; 2nd layer (L2) is user/participant discovery and authorization layer; 3rd layer (L3) is social control interaction layer; 4th layer (L4) is aggregation consensus layer; and 5th layer is device control layer (L5).

The system according to the embodiment may convert or modify exclusively controlled actuators in a public or common space into truly public or common actuators. By designing the high uncertainties of the common space into 5 particularized layer architecture, the visitors may instantly participate in democratic, collective control of the actuators.

Also, numerous ready-made and other actuators may be easily integrated without altering or modifying (the) implementation methods.

The system may comprise three elements, including mobile app of a user's mobile device; a control server, which located on site at the premise or the cloud; and a public or common actuator, which is installed in the common space.

The main functions/operations of the system are as follows. First, the system presents a new concept of “area of influence” authentication: the participants are dynamically granted the votership upon approaching an area of influence (AoI). Here, the area of influence may denote a spatial area under physical influence of the actuator's operation (e.g., sound from a public speaker). Second, the system may apply utility-based preference aggregation, and flexibly abstract and incorporate diverse aggregation and consensus-building policies, reflecting different social and spatial contexts. Third, the system may further enable asynchronous and continual decision-making, and ensure fair and efficient use of the actuators; the participants may express their preferences at their own moments of their choice or will, and through this, their current decision may be continuously updated. Fourth, the system may cover heterogeneity of the actuators and their native control APIs, using a common abstraction of the control operations. Upon consensus on the control, the system may automatically generate an actual control command complying with vendor-specific native APIs. The system may provide a social control interface and assist the participant to easily elicit and express their preferences in the context of social control and consensus building, beyond the exclusive one-to-one control.

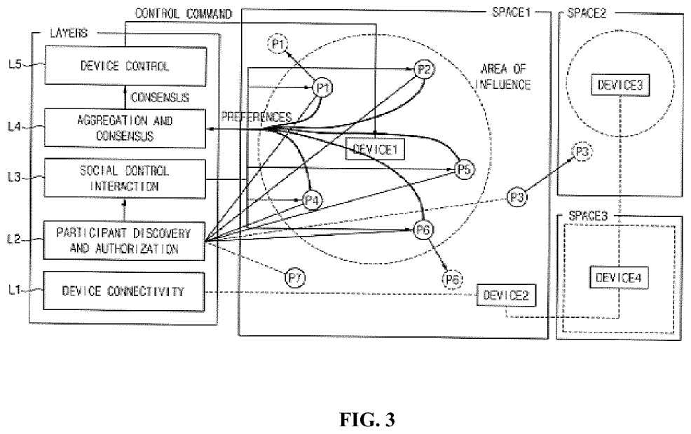

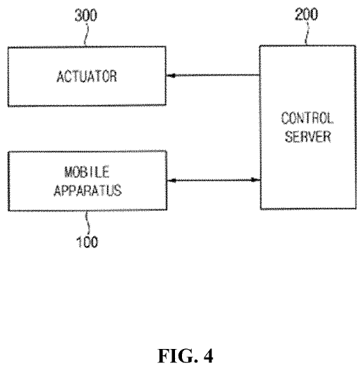

FIG. 3 shows a concept diagram of a system of social control and use of IoT device, according to an embodiment.

Referencing FIG. 3 (and FIG. 1 and FIG. 2), IoT technology provides a new horizon to a system for social use and control of isolated IoT devices. Importantly, It opens the door to social control and use of the devices and enables overcoming of the long-standing perception not only on the resulting limitations of existing interface designs but also on the exclusive, closed control of the devices. However, the discussions on most IoT technologies are centered on providing and leveraging remote connectivity and automating related processes. IoT technology in terms of its social control and use has not been adequately studies despite its enormous potential.

In the embodiment, the three entities associated with the social control and use of IoT device may include: devices (DEVICE 1, DEVICE 2, DEVICE 3, DEVICE 4), spaces (SPACE1, SPACE2, SPACE3) and participants (P1, P2, P3, P4, P5, P6, P7). The device(s), space(s), and participant(s) may each have a high level of diversity and heterogeneity, and when the 3 entities co-exist, situation may worsen due to the diversity and heterogeneity

Contexts encompassing social control and use in a space are complex and dynamic, and providing a systematic view and effective tools to deal with this complexity may require an architecture-based approach.

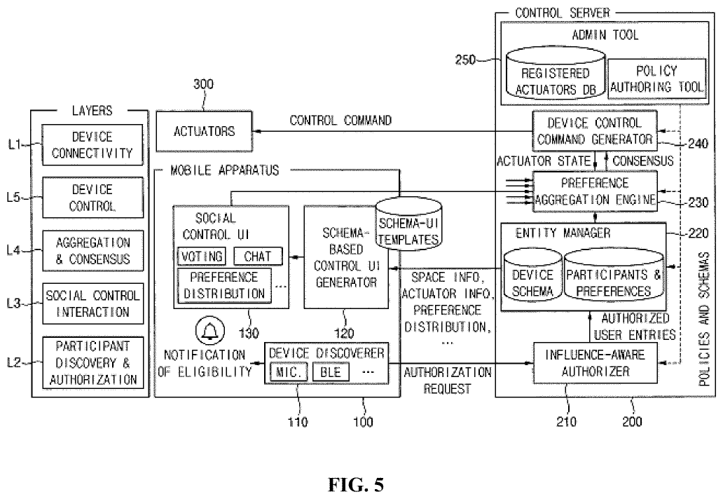

FIG. 3 shows the exemplary architecture of social control and use of an IoT device. For “instant social control and use in public or common space,” the architecture may be further refined. Specific implementation of the architecture is shown in FIG. 4 and FIG. 5, later.

Apparatuses or Devices (DEVICE 1, DEVICE 2, DEVICE 3, DEVICE 4):

Architecture may need to be developed to integrating ever-increasing diversity and heterogeneity of IoT devices. It may have different types of control interfaces, such as ON/OFFs, sliders, mode selections, and keypad inputs. It may also allow remote or timer trigger control. Also, devices from other vendors may have vendor-specific APIs. In addition, the architecture should consider various spatial, space-specific meanings according to area of influence (AoI). Some devices (e.g., heaters, air conditioners, and air purifiers) may be designed to influence or affect the surrounding environment uniformly, while others (e.g., public displays, speakers, and lighting fixtures) have directional influences, which may decrease with/over distance.

Spaces (SPACE1, SPACE2, SPACES):

Various characteristics of a space may affect how the devices installed within the space operate. Spaces may be different in type and purpose (e.g., hospital, school bus, airplane, park, restaurant, etc.). Various other aspects of the space should also be considered: such as whether it is public or private, whether it is open or closed, different sizes, and presence of administrative staff.

Participants (P1, P2, P3, P4, P5, P6, P7):

Participants may be people from various groups. Participants' personality, age, health status, physical ability, and cultural background may differ from each other, and therefore, their attitude, behavior, and preference towards manner in which devices are controlled and used may also differ. This may make the social control and use of IoT devices very complex and difficult.

In the present system, there are many factors to be considered, such as eligibility of participants, whether the participant is one-time user or frequent users (or visitors) of the device (or the space), whether the relationship between/among the participants is that of strangers or acquaintances, and physical location (whether the participants or their devices are in the same room or away from each other).

FIG. 3 shows a high-level overview of the architecture in the context of dynamic interactions between/among the spaces and participants. The architecture is developed by applying the principle of separation of concerns, multiple times.

At a high level, problems of participant complexity may be separated from problems of device complexity. Participants' interaction with devices may be managed exclusively by a virtually designated agent. Furthermore, issues with real human behavior (for devices or other participants) and issues with social decision (or consensus) processes may be separated into different layers: social control interaction layer (L3) and/or aggregation and consensus layer (L4). The social control interaction layer (L3) may provide participants with understanding of social context and action radius of the space. Therefore, it may directly affect acceptability of the system. The aggregation and consensus layer (L4) may be important as it influences participants' trust and willingness to agree on social control and use. The aggregation and consensus layer (L4) may provide a frame capable of integrating various alternative policies to be selectively used in various situations.

The participant discovery and authorization layer (L2) may be important as it is a major source of issues related to diversity and fluidity (e.g., mobility). The participant discovery and authorization layer (L2) may potentially reduce complexity of the overall system operation at an early stage.

Device Connectivity Layer (L1):

This layer (L1) provides the device with internet connectivity, allowing social control and use of the device. A conventional IoT infrastructure may serve as a basic substrate.

Participant Discovery and Authorization Layer (L2):

This layer (L2) identifies potential participants and authorizes them if appropriate for social control and use of the device. This layer (L2) may identify who appears in and disappears from the space, and initiate handshaking with each person present, and go through an authorization process, and provide feedback on the results.

The participant discovery and authentication layer (L2) may consider various policies and mechanisms for discovery and authorization. There may be various policies and eligibility criteria, and this layer (L2) may consider details of the three entities: the devices, spaces and participants for appropriate selection. The above eligibility criteria may consider physical condition of a visitor, the area of influence (AoI) of the device or member-eligibility (e.g., voting rights only for passengers holding tickets at train stations). Also, in this layer (L2), delegation of voting rights may also be considered (e.g., a parent at work participating in air conditioning control of a kindergarten bus). In addition, various mechanisms may be considered in this layer (L2), such as a mechanism based on visitor profile, registration, visitor location detection and/or device influence detection.

As an additional issue, protection from security and personal threats such as fake participants or anti-social behavior may be considered in this participant discovery and authorization layer (L2).

Social Control Interaction Layer (L3):

This layer (L3) supports social interaction between/among participants to support the participants to express their intentions and opinions, i.e., preferences, and facilitate collective decision-making. A carefully designed social control interface may go beyond one-to-one exclusive, monopolistic control and allow the participants to easily derive and specify preferences in the context of social control. This layer (L3) may generate such an interface and pass it on to legitimate participants as approved by the participant discovery and authorization layer (L2).

From a larger perspective, this layer (L3) may help participants to reach consensus in an efficient and acceptable manner with respect to the aggregation and consensus layer (L4). This layer (L3) may also maintain a list of currently approved participants for each device.

This layer (L3) may consider burden of participants participating in interactions with other devices and interfaces. The participants may become dismayed or frustrated when, for example, in a case with a commonly used device but with an unfamiliar interface, and this burden may be amplified in a newly visited space.

Furthermore, articulating a preference for social control may be subtle and tedious. This may be determined by delicate social context of the space and the participants' perceptions of ongoing process of consensus building. In this social control interaction layer (L3) several issues may be considered, including coherent interfaces across different devices and spaces, instantaneous automatic distribution of interfaces, visualization of preference distributions (i.e., summarizing the preferences of others), feedback channels, and preference elicitation, etc.

Aggregation and Consensus Layer (L4):

This layer (L4) provides policies and mechanisms for collecting preferences from multiple participants and mediating them to reach consensus on various preferences using the support of the social interface of the social control interaction layer (L3). This layer (L4) may often be a complex and ambiguous process that may require iterative or continuous improvement with persuasive feedback beyond a single pass process. This layer (L4) may include a mechanism for integrating and executing social rules set for each space. In addition, functions such as anti-social behavior prevention may be considered in this layer (L4).

Device Control Layer (L5):

This layer (L5) performs social control of the device according to the consensus derived from multiple participants through the aggregation and consensus layer (L4). Basic issue of this layer (L5) is to provide a mechanism to select and invoke appropriate device control API. However, various devices and APIs may cause problems, and naive approaches (e.g., how to specify devices or spaces) may limit the scope and adoption of a/the system. Thus, to this end, an abstraction may be devised to hide diversity and heterogeneity and an automated tool provided to generate control enforcement mechanisms upon the abstraction.

Referring to FIG. 3, a 1st device (DEVICE 1) may be disposed or located in a 1st space (SPACE 1). The “area of influence” of the 1st device (DEVICE 1) may be defined as a distance from the 1st device (DEVICE 1). A 1st participant (P1), 2nd participant (P2), 4th participant (P4), 5th participant (P5), and 6th participant (P6) may be within the “area of influence” of the 1st device (DEVICE 1), and the 1st participant (P1) and 6th participant (P6) may move out of the “area of influence” of the 1st device (DEVICE 1).

A 2nd device (DEVICE 2) may be located in the 1st space (SPACE 1), but the “area of influence” is not shown. For example, the 2nd device (DEVICE 2) may not be operating.

A 3rd device (DEVICE 3) may be located in a 2nd space (SPACE 2). The “area of influence” of the 3rd device (DEVICE 3) may be defined as a distance from the 3rd device (DEVICE 3).

A 4th device (DEVICE 4) may be located in a 3rd space (SPACE 3). The “area of influence” of the 3rd device (DEVICE 3) may be defined along a wall or boundary of the 3rd space (SPACE 3).

For example, the influence of the first device (DEVICE 1) and the 3rd device (DEVICE 3) may decrease with (the) distance, and may be speakers, light fixtures etc.

For example, the influence of the 4th device (DEVICE 4) may be uniform in the space (SPACE 3), and may be a heater, air conditioner, air purifier, or the like. With heaters, air conditioners, and air purifiers in some cases, the influence(s) may have a direction or vary depending on (the) distance, but in certain space, may also be assumed to be uniform within.

FIG. 4 shows a block diagram of the system of social control and use of IoT device of FIG. 3. FIG. 5 shows a block diagram of the system of social control and use of IoT device of FIG. 4.

FIG. 4 and FIG. 5 show a system for social and democratic control and use of actuators in a common space, based on the architecture described in FIG. 2 and FIG. 3. The actuators in the system may operate in a manner determined by the general public.

Realizing and implementing such system may be very complex. With an open approach to a space, uncertainty is unavoidable. A space may be an indeterminable object whose context is dynamic and unpredictable. Because it is difficult to adopt common strategies useful for its design, unique design requirements and goals of the system may be necessary. The design goals of the system are as follows.

Comprehensive Coverage of Actuators:

The system may incorporate a large number of off-the-shelf or ready-made actuators that may be installed or placed in a common space. A single uniform “polling place” here visitors may easily vote on their preferences for the operations of all the actuators that the visitors participate in may be provided.

Asynchronous and Continuous Decision Making:

It is rare for all visitors in a space to express their preferences at the same time. There are continuous inflow and outflow of visitors, and the visitors' preferences may change during their visit or stay. The system may accommodate new votes from the visitors at any time, and may continuously update current decisions accordingly.

Transparency in Decision Making:

Decision making should allow participants to understand the process and results transparently.

Instant Participation:

People visit various public or common spaces. These people may come and go freely only for a short period of time. Thus, the system may be designed for instant and easy participation.

Area-of-Influence (AoI) Dynamic Grant of Voting Rights:

When a visitor is influenced by an actuator (e.g., if the visitor is in an area around an IoT speaker and conscious of the music being played), it may be intuitive to entitle the visitor to vote. In this respect, the system may allow the visitor to be given the right to vote without having to do anything other than simply entering the area of influence (AoI). On the other hand, the system may not grant voting rights to people who are not in the space but attempt to manipulate the operation of the actuator.

Programming-Free Instantiation:

The system may be instantiated in a way that does not require programming. Given a huge number of common spaces and associated actuators, it may not be realistic for each actuator in operation to modify its implementation. A/The space manager who is responsible for the actuators in the space need not be a programming expert.

In the present disclosure, the system may comprise a visitor's mobile apparatus or device (100), a control server (200) and a public or common actuator (300). The system may further comprise auxiliary or support apparatus or device for discovery and authorization. FIG. 4 and FIG. 5 show one mobile device (100) per convenience of disclosure, but the system may comprise a plurality of mobile device(s) (100), and a plurality of participants may each possess the mobile devices (100).

The control server (200) may perform authorization as to the mobile device (100), and generate and output user interface for voting to the mobile device (100). The mobile device (100) may output a voting value which indicates the participant's preference to the control server (200). The control server (200) may derive consensus based on the voting value(s) received from a plurality of user's mobile device (100), and generate a control signal based on the consensus, and output the control signal to the common actuator (300). The participants' preferences may be reflected to control the common actuator (300).

For example, the voting may mean that the user directly expresses an intention by using the user interface. For example, the voting may include a concept of automatically transmitting a set value which is previously set by the user to the control server (200). For example, the voting may include a concept in which an artificial intelligence system recognizes the user's context (body, activity, environment context) and automatically transmits a recommended setting to the control server (200).

The common actuator (300) may include a button attached to IoT device (e.g., the power button of a monitor), a button connected to IoT device by wire (e.g., light switch), a button wirelessly connected to IoT device (e.g., remote control), and a button connected to IoT device via the Internet (e.g., IoT button, software button).

The mobile device 100 may comprise a device discoverer (110), a schema-based control user interface (UI) generator (120), and a social control user interface (UI) (130). The mobile device (100) may perform operations of the device discoverer (110), the schema-based control UI generator (120), and the social control UI (130) in (a) form of a mobile app. The schema-based control UI generator (120) may use a schema UI template. The social control UI (130) may perform a voting function (VOTING), preference distribution visualization function (PREFERENCE DISTRIBUTION), and chatting function (CHAT).

The control server (200) may comprise an influence-based or influence-aware authorizer (210), entity manager (220), preference aggregation engine (230), device control command generator (240), and admin/management tool (250). The entity manager (220) may manage the device schema, participants and preferences.

The preference aggregation engine (230) may derive consensus by aggregating values voted for from the plurality of the mobile devices (100). The device control command generator (240) may generate a device control command (CONTROL COMMAND) based on the consensus.

The entity manager (220) may manage the IoT device, the public or common space, and the participants as operated by the common actuator (300). The entity manager (220) may output information of the common space, information of the IoT device, and information of the preference distribution of the participant to the mobile device (100).

The schema-based control user interface (UI) generator (120) of the mobile device (100) may generate the social control user interface based on the information of the common space and the information of the IoT device. The schema-based control user interface generator (120) may reference the preference distribution information of the participant to generate the social control user interface.

For example, the schema-based control user interface (UI) generator (120) may generate an interface suitable for operational or control modality of the IoT device. For example, when the modality of the IoT device is volume and temperature, a slider-type user interface may be generated. For example, when the modality of the IoT device is volume and temperature, a user interface in a numeric input format may be generated. For example, when the modality of the IoT device is power, an ON/OFF switch type user interface may be generated. For example, when the operation modality of the IoT device is playlist selection or airflow/volume selection, a radio button type user interface may be generated.

The device discoverer (110) of the mobile device (100) may detect a nearby beacon to notify that a visitor may exist within the area of influence of the common actuator (300). The influence-aware authorizer (220) of the control server (200) may determine whether the visitor is a participant based on physical state of the visitor and the area of influence (AoI) of the IoT device, and may grant the participant right to social control and use of the IoT device.

In the present embodiment, a case where the device discoverer (110) of the mobile device (100) and the common actuator (300) use a beacon method is exemplified, and for the beacon method, Bluetooth and BLE (Bluetooth low energy) or Wi-Fi may be used.

Further although the case where the device discoverer (110) of the mobile device (100) and the common actuator (300) use a beacon method is exemplified, distance measuring technology of the present invention is not limited to the beacon method, and may include various radio/sound wave-based methods such as ultra-wideband (UWB), light detection and ranging (LIDAR), and sound navigation and ranging (SONAR).

The admin tool (250) may comprise a registered actuators database and a policy authoring tool. The policy authoring tool may set an aggregation policy and an authorization policy. The policy authoring tool may output the aggregation policy to the preference aggregation engine (230), and output the authorization policy to the influence-aware authorizer (210).

The system may be designed based on the 5-layer architecture described with reference to FIG. 2 and FIG. 3.

The participant discovery and authorization layer (L2) of the system may adopt an instantaneous participation and area of influence/AoI-based authentication policy. The system may provide both a physical influence sensing-based and a location-based mechanism for AoI estimation. Also, the authorization process may not require explicit interaction on the part of a participant. The instant participation may be implemented through an app that is shared between various spaces and devices. The instant participation may only need to be registered once with the system. When the mobile device (100) enters a space or encounters an actuator (300) instantiated in the system, a user may be automatically notified as to a potential eligibility (NOTIFICATION OF ELIGIBILITY) to participate in control of the actuator (300) via the mobile device (100). The participant discovery and authorization layer (L2) of the system may comprise two main elements: the device discoverer (110) in the app of the mobile device (100) and the influence-aware authorizer (210) in the control server (200).

The social control interaction layer (L3) of the system may provide a social control user interface to the participant using a schema-based approach. The social control interaction layer (L3) may include a unified voting interface (VOTING), a preference distribution visualization (PREFERENCE DISTRIBUTION), and a chatting user interface (CHAT). The system may also show an applied aggregation policy (e.g., majority vote). All of these features may provide transparency in decision-making and a coherent view to overcome heterogeneity of interfaces.

The social control interaction layer (L3) may include three main elements: schema-based control user interface (UI) generator (120), entity manager (220), and social control user interface (130).

The schema-based control user interface (UI) generating unit (120) may automatically configure the social control user interface (UI) (130) instantly as a/the participant is authorized and delivers it to each participant. The schema-based control user interface (UI) generator (120) may additionally provide a state descriptor including summary information on a state of an/the actuator to help the participant determine his/her preference. The schema may be imported from the Registered Actuators DB, which stores actuator-specific information.

With respect to the aggregation and consensus layer (L4), the system may adopt current utility-based approach, that is, the participant's total utility optimization method. The utility may be determined according to a policy configured by an administrator of the space. In addition, to facilitate the aggregation phase, asynchronous voting of preferences and iterative and continuous refinement/improvement methods may be employed. The aggregation and consensus layer (L4) may comprise two main components: preference aggregation engine (230) and policy authoring tool.

The device control layer (L5) of the system may comprise device control command generator (240) which invokes a basic device API for each device and generates a command for updating device state. For example, the device control command generator (240) may use openHAB. To expand the scope of application, the system may cooperate with an external gateway to further integrate other devices that do not support IoT.

System Setup:

Instantiation may be done by the space manager. The space manager may simply set a high-level set of configuration parameters to reflect operating requirements of the actuator and space. The system may provide tools to effectively hide and select details of various actuators, and support (the) administrators to specify their requirements according to their needs. Thus, the space manager may easily convert a conventional, general actuator into an actuator operating in the present system.

The device manager may select an actuator and a function or operation to be executed in the manager console (e.g., select an air conditioner and its temperature range). The device manager may set an authorization policy and an aggregation policy using the policy authoring tool. The device manager may install auxiliary devices such as BLE beacons and gateways on site. For example, the policy authoring tool may output the aggregation policy to the preference aggregation engine (230) and output the authorization policy to the influence-aware authorizer (210).

Handshaking:

When a visitor approaches an actuator, the app on the mobile device (100) executing the device discoverer (110) in the background may detect a nearby beacon, indicating/informing that that the visitor is within the area of influence (AoI) of the actuator. The app may initiate an authorization step of invoking or calling the influence-aware authorizer (210).

To cope with other different kinds of devices, it may be important to provide a unified abstraction of the devices. It may also be imperative to separate actual enforcement of device control from other issues of social control and use, such as authorization, social interaction and aggregation. Through such separation, various policies and mechanisms may be invented and experimented. The experiments may be performed without technical or implementation details of individual devices. For abstraction and isolation, the system may utilize a home automation system, which is recently developed by the open-source community. The device control may be enforced at high level, without checking details of vendor-specific native APIs or writing control codes. For example, for air conditioning units from a specific vendor, the space manager may define AC_TEMP as a control variable. Schema for the control variable may be retrieved in a form <name=“AC_TEMP”, type=Number, attributes={min:18, max:26}>. Upon consensus of setting the AC_TEMP to 23, control may be enforced in a form of <set, “AC_TEMP”, 23>. In addition, the space manager may compose an aggregation policy using the schema, and may configure a social control interface (e.g., a slider in the form of a number).

To support actuators with legacy interfaces such as IR signals or mechanical-motion-based interfaces, the system may utilize IoT-supported bridge devices that mimic these signals or motions. For example, a universal IR remote control may emulate a remote control by sending an IR signal of the same pattern to an existing actuator. Similarly, a smart plug may mimic a physical power switch of a connected actuator. The system may be easily extended to include other home automation systems, and additional technologies such as Lumos or EPODOSITE may be additionally applied to support devices without an open API.

Decision making in the system may follow an aggregation policy configured by the space manager. The system may provide a policy authoring tool for the space manager to encode social rules appropriate for the space.

In present system, resource sharing may be performed based on two main factors, fairness and efficiency.

To quantify user satisfaction, the system may utilize a utility function. The utility function may receive a user preference for a state of an actuator as an input and return a quantified satisfaction between 0 (“unhappy”) and 1 (“happy”). The utility function may model (perform modeling of) the user satisfaction without a need to manually annotate or set all possible options. The utility function in two types (Nominal and Ordinal) may be presented for two different scales of actuator variables.

Nominal: Actuator variables such as music playlists or TV channels are may have a nominal scale. The utility function of the nominal scale may be Formula (1) below.

$$〈 Formula 1 〉$$

$$U ( {p}_{i} , s ) = \{ \begin{matrix}1. & if s ∈ {p}_{i} \\ 0. & if s ∉ {p}_{i}\end{matrix} \begin{matrix}U : utility function \\ {p}_{i} : selected options \\ s : state of an actuator\end{matrix} \qquad ( 1 )$$

Here, U denotes the utility function; pi denotes option(s) selected by participant i; s denotes state of an actuator; and i denotes (the) participant. When the state s of the actuator is between/among the options selected by the participant i, utility value is 1 (“happy”), and if not, 0 (“unhappy”).

Ordinal: Actuator variables such as fan speed (ordinal) and temperature (interval) of an air conditioner or the ratio of amplitude (ratio) of a loudspeaker may have degree (orders) between/among the options. In the system, the user satisfaction may be modeled based on a distance between the state of the actuator and the user preference. For example, when the distance between the state of the actuator and the user preference increases, the satisfaction may decrease. For example, when the state of the actuator and the user preference match, the utility value may be 1, and as the distance between the state of the actuator and the user preference gradually increases, the utility value may gradually decrease toward 0. For example, the satisfaction may be determined based on L1 distance or L2 distance.

The space manager may allow a user to select multiple preferences. Assuming that all preferences have equal priority, the unary utility function may be extended to be multivariate. Here, maximum output of the unary function value may be taken.

The system may provide three basic primitives (elements) for the aggregation policy: Efficiency (mode 1), Fairness (mode 2), and State Precedence/Priority (mode 3). The system may formulate optimization problem of these basic primitives as follows.

Mode 1: Efficiency

Efficiency (mode 1) may maximize total utility of the users and may be defined as in Formula 2 below.

$$〈 Formula 2 〉$$

$${s}_{next} = {arg max}_{s ∈ S} \vert {\sum }_{i ∈ I} U ( {p}_{i} , s ) \vert \begin{matrix}I : set of participants \\ {s}_{next} : next actuator state \\ S : set of state variable options\end{matrix} \qquad ( 2 )$$

Here, I is a set of participants; sₙₑₓₜ is next state of an actuator; and S is a set of variable options of state of the actuator. i denotes each participant in the set I. s denotes state of each actuator in the set S. That is, the next state (sₙₑₓₜ) of the actuator may be determined as the state (s) of the actuator which maximizes total/sum of the utility values (U) of all of the participants (i). For example, when in the mode 1, sum of the utility values is 100 for all participants in a 1st state, and the sum is 120 in a 2nd state, and the sum is 150 in a 3rd state, the next state of the actuator may be determined as the 3rd state.

Mode 2: Fairness

Maximum-minimum fairness (mode 2) may be used to achieve fairness in resource sharing. The mode 2 may consider a utility value at a (specific) point of time. However, since the utility function for the nominal variable has a value of 0 or 1, utility may not be distributed fairly at a (specific) point of time.

In the present system, utility may be distributed over time so that the users may receive utility (satisfaction) in turn. Fairness (mode 2) may be defined as in Formulas 3, 4, and 5 below.

$$〈 Formula 3 〉$$

$${U}_{prev} = {\sum }_{t = τ - ω}^{r - 1} U ( {p}_{i , t} , {s}_{t} ) ,$$

$$〈 Formula 4 〉$$

$${U}_{exp} = {\sum }_{t = τ}^{τ + δ ( s )} U ( {p}_{i , t} , s )$$

$$〈 Formula 5 〉$$

$${s}_{next} = {arg max}_{s ∈ S} {min}_{i ∈ I} [ {U}_{prev} + {U}_{exp} ] \qquad ( 4 )$$

Here, Uₚᵣₑᵥ is cumulative (accumulated) satisfaction of past; Uₑₓₚ is estimated satisfaction of future; r is current time; ω is time window for calculating the accumulated satisfaction of the past (Uₚᵣₑᵥ); δ(s) is expected duration that state s holds or is expected to continue in the future; p_{i,t} is option selected at time t by participant i; and sₜ is state of an actuator at time t.

The time window may consider both recent past co and near future δ(s). The parameters may be set by the space manager by considering the participant's visit pattern. As shown in <Formula 5>, the system may determine the next state (sₙₑₓₜ) of the actuator by utilizing the past cumulative satisfaction and future expected satisfaction. The next state (sₙₑₓₜ) of the actuator may be determined as a state in which the sum (Uₚᵣₑᵥ+Uₑₓₚ) of the participant having the smallest sum of past cumulative satisfaction and future expected satisfaction (Uₚᵣₑᵥ+Uₑₓₚ) becomes the largest. For example, when a 1st state is determined as the next state (sₙₑₓₜ) the participant (e.g., a 1st participant), who has the smallest sum of past cumulative satisfaction and future expected satisfaction (Uₚᵣₑᵥ+Uₑₓₚ), has 0.3 as the sum (Uₚᵣₑᵥ+Uₑₓₚ); and when a 2nd state is determined as the next state (sₙₑₓₜ) the participant (e.g., a 2nd participant), who has the smallest sum of past cumulative satisfaction and future expected satisfaction (Uₚᵣₑᵥ+Uₑₓₚ), has 0.4 as the sum (Uₚᵣₑᵥ+Uₑₓₚ); and when a 3rd state is determined as the next state (sₙₑₓₜ) the participant (e.g., a 3rd participant), who has the smallest sum of past cumulative satisfaction and future expected satisfaction (Uₚᵣₑᵥ+Uₑₓₚ), has 0.6 as the sum (Uₚᵣₑᵥ+Uₑₓₚ); the next state (sₙₑₓₜ) may be determined as the 3rd state.

Mode 3: State Precedence

Efficiency (mode 1) and Fairness (mode 2) are effective in most cases, but in some cases, they may not operate as desired. In the mode 3, following two limitations may be considered: oscillation and space-specific restriction.

Oscillation: Oscillation in a state of an actuator may occur under certain circumstances. For instance, an IoT speaker following the Fairness (mode 2) policy generated an incident where it constantly moved between two playlists every few seconds. The playlists were shown to have been chosen by two least satisfied visitors, and this oscillation caused the song to stop at the intro. As a result, the user satisfaction was greatly reduced.

Space-specific Restrictions: Public or common spaces may have space-specific restrictions. For example, the restrictions may include turning off lights at night, limiting the air conditioner temperature to save energy, not playing music too loudly, and the like. The above restrictions may be managed by the space manager, or it may have already been agreed upon among the people. For example, the owner of a guest house may want to turn off the lobby lights at bedtime. Such will of the guesthouse owner may be interpreted as turning off the lobby lights at bedtime unless the guesthouse users unanimously agree to be otherwise. These restrictions may not be easy to implement with the above Efficiency (mode 1) and Fairness (mode 2) policies.

In order to solve the oscillation and space-specific restrictions, the system may apply State Precedence (mode 3). The mode 3 includes two main functions. First, the oscillation problem may be prevented by temporarily giving the current state a high priority. For example, the system may give the current playlist higher priority than other playlists until the first song is finished. The space manager may adjust expiration time of the temporary priority by using a timeout parameter. Second, the mode 3 may solve the space-specific restriction problem by designating priorities between states. For example, for bedtime in a guest house, the space manager may give higher priority to the OFF state of lobby lighting. The system may set to turn off the lobby lights unless all participants prefer the ON state.

The system may also combine the three basic elements (mode 1, mode 2, and mode 3) to determine the state of the actuator. The system may compare the scores of the three basic elements. The space manager may set priorities among the three basic elements. For example, in a case of configuring of a playlist, priority of [State Priority (mode 3) (in the current playlist), Fairness (mode 2), and Efficiency (mode 1)] may be set. In the configuring of the playlist, the system may determine the next playlist by applying the State Priority (mode 3) first, and when the score of the State Priority (mode 3) is a tie, the Fairness (mode 2) and Efficiency (mode 1) may be sequentially applied. In the system, the state of the actuator may be determined based on a weighted sum of the three basic elements (mode 1, mode 2 and mode 3).

Algorithm for aggregation and decision making, which includes the Modes 1, 2, and 3, may be expressed as follows.

Algorithm 1: Aggregation and decision making

| input : S ← List of available states | |
|---|---|
| input : I ← List of active occupants | |
| input : U(p_{i,t}, sₜ) ← Utility of an occupant i with preferences | |
| p_{i,t}, state s, and time t | |
| input : τ ← Current time | |
| input : ω ← Look-back size for time window | |
| input : δₚ ← Expected duration for a state s | |
| input : Φ ← List of policies (ordered) | |
| input : γ_{s:} ← Precedence weight of a state s | |
| input : γ₀ ← Precedence threshold | |
| input : τ₀ ← Precedence timeout | |
| input : s_{now} ← Current state | |
| input : τ_{now} ← Elapsed time of the current state | |
| output: sₙₑₓₜ, Next state | |
| candidate_states ← S; | |
| foreach ϕ in Φ do | |
| max_score ← −∞, best_choice ← ( ); | |
| foreach s in candidate_states do | |
| score ← 0; | |
| if ϕ = efficiency then | |
| score ← Σ_{i∈τ} U(p_{i,τ}, s); | |
| else if ϕ = fairness then | |
| score ← min_{i∈τ} | {Σ_{t = - ω}^{τ = 1} U(p_{i,t}, sₜ) |
| | + Σ_{t = τ}^{τ + δ}^{ₛ} U(p_{i,t}_{, s}_{ₜ}_{)};} |

```
    else // ϕ = precedence
      count ← Σ_{i∈τ} [U(p_{i,τ}, s)];
      score ← γₛ if count > γ₀ and τ_{now} < τ₀ else 0;
    end
    if score > max_score then
      best_choice ← [s];
      max_score ← score;
    else if score = max_score then
      best_choice.add(s);
  end
  candidate_states ← best_choice;
end
sₙₑₓₜ ← random.choice(candidate_states);
```

Hereinafter, explained is who should be given a right to vote (that is, who should be given control). As a basic policy for determining voting eligibility, “an area of influence or AoI based authorization” may be used to grant rights only to those people who are directly influenced or affected by an actuator. For example, a person who can hear music from a speaker will be given control of the speaker, and a person who is affected by the ambient air temperature due to a heater may receive control of the heater.

That is, when optimizing the utility of an actuator, it may take into account, preferences of people who physically perceive the utility of the actuator. Equally important, the system may exclude people who are not currently (being) influenced by the actuator from voting. A vote of an outsider who is not influenced by the actuator may prevent the actuator from serving the visitors' best interests. In extreme cases, an outsider's vote may be a malicious vote to destroy the environment of the space.

For the influence-aware authorization, the system may continuously monitor whether visitor(s) is/are within an area of influence (AoI). Given that a public or common space is freely accessible by everyone, it may be impossible to predict who will currently be included within the area of influence of the actuator. To accomplish these tasks, two approaches are presented below, according to complexity of the area of influence (AoI).

(1) Localization-based Decision: One family of actuators includes heaters, air conditioners, air purifiers, diffusers, and humidifiers, and the like that are designed to maintain a space to be spatially uniform and intermittently constant/consistent. To prevent such actuators from losing their influence or effects, these actuators may be installed in a walled space. Therefore, the AoI of this actuator family may be determined by division of the space, such as a room. Thus, the AoI may be determined by employing a room-level localization or proximity sensing (e.g., BLE beacon) technologies. Even in very large places with uncertain boundaries (e.g., airport terminals, hotel lobbies), the AoI of actuators may be statically determined by using determined statically via HVAC simulation tools of the entire building.

(2) Physical Influence Sensing: However, for other actuator families (e.g., public displays, speakers, and lighting fixtures), room-level localization or proximity sensing technologies may not be adequate to estimate whether a visitor or user is in an AoI of an actuator. The AoI of these actuators may exhibit directionality and decay with distance, resulting in an AoI of a very complex shape. For example, surrounding objects may block, reflect, or diffract the actuators' emitted video, sound, and light. External noise or external light (e.g., sunlight) may interfere with the visitor's perception. Strength of the actuators' signal and content of the signal (e.g., speaker volume and music genre) may also affect the AoI. More importantly, these factors may not be fixed and change over time. Due to these, it may be nearly impossible to pre-simulate or pre-profile the AoI of the actuator. To solve these problems, perception-aware influence detection may be used to complement (the) localization-based decision methods.

The perception-aware influence detection strategy may be based on ways that people naturally perceive sound. In other words, if the visitor can hear the speaker, it can be said that the visitor is being influenced or affected thereby.

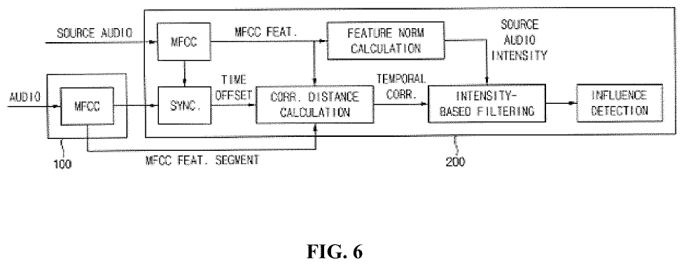

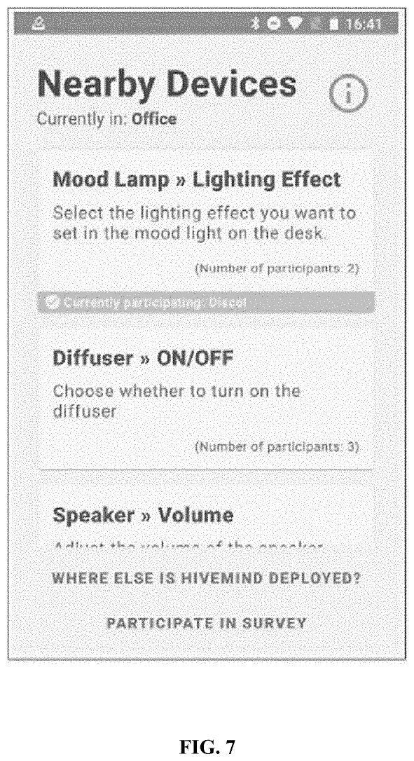

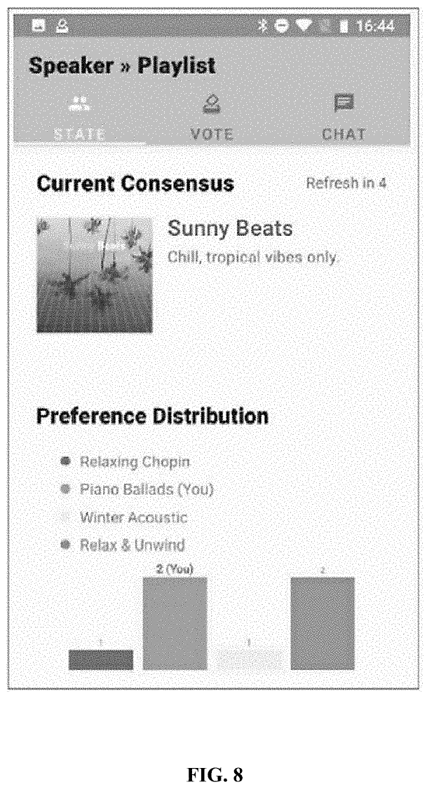

FIG. 6 shows a concept diagram of operation of the influence-based or influence-aware authorizer (210) of FIG. 5. Referencing FIG. 6, the method (e.g., flow) shown may be used in a visitor's mobile device. For example, temporal correlation between source signal of a speaker and signal received from the visitor's mobile device at a given location may be utilized. When the correlation exceeds a threshold value, it may be determined that the visitor is within a/the area of influence (AoI).

Such method may naturally eliminate a need for a sophisticated model of acoustic environment in which many indirect and place-specific properties are combined and a need for correction. Also, it may be simple, straightforward to consider genre- or content-dependencies.

Temporal correlation-based method may be used to detect a co-location of the visitors/users and devices using audio signals. In the present system, such method may be applied to directly measure a degree of physical influence which visitors receive from actuators.

FIG. 6 shows pipeline of perception-aware influence detection. The user's mobile device (100) may record audio or sound from the surrounding for a short time frame and extract a feature (e.g., MFCC) from the audio, and transmit to the control server (200). The control server (200) may concurrently extract a feature (e.g., MFCC) from source audio and synchronize time offset of the two feature(s) (segments), and calculate time-averaged value correlation distance between the two (audio features, segments). When the time-averaged value correlation distance exceeds a threshold value, the system may determine that the user is within the area of influence (AoI) of the speaker.

The audio feature may be raw signal, Short-time Fourier transform (STFT)-based audio fingerprint, and WSSIM2, etc. . . . .

In addition, in the perception-aware influence detection, performance and power resource (battery life) may be optimized by ignoring a case with low volume and by using duty cycling, (respectively).

Referencing FIG. 6, the mobile device (100) may receive an audio signal using a microphone and extract a feature of MFCC. The control server (200) may receive a source audio signal and extract a feature of MFCC. The control server (200) may synchronize (SYNC.) a time offset between a 1st MFCC of the mobile device (100) and a 2nd MFCC of the control server (200). By comparing time-offset synchronized 1st MFCC and 2nd MFCC, a temporal correlation distance may be calculated (CORR. DISTANCE CALCULATION). NORM may be calculated for the source audio signal (FEATURE NORM CALCULATION). The temporal correlation distance (TEMPORAL CORR.) may be filtered with strength of the source audio signal (SOURCE AUDIO INTENSITY). The influence may be detected based on the temporal correlation distance filtered by the intensity of the source audio signal.

The perception-aware influence detection strategy is an intuitive way of measuring physical influence of an actuator without prior profiling or simulation. However, two requirements may limit the strategy's applicability: the actuator's “signal” must (1) exhibit a unique pattern and (2) be continuously monitored at the mobile device (e.g., smartphone. Thus, it may be difficult to apply the strategy to other types of actuators. For example, a lighting device may not have a unique pattern necessary to determine temporal correlation. For actuators without a unique pattern, unperceivable side-channel communication may be considered. For lighting devices, visible-light-based localization technology may be utilized. A steady light can carry a modulated signal which is invisible to humans, and after the modulated signal is captured by a light sensor in the visitor's mobile device, the detection may be performed at the control server side by using the temporal correlation.

The authorization flow of the system may comprise 2 steps.

Step 1: Site Discovery

The visitor's mobile device (100) may first recognize an encountered site using a BLE beacon. Along with a site identifier, the beacon may broadcast a short-lived token, which changes every 5 seconds, to prevent replay attacks.

Step 2: Influence-Based or Influence-Aware Authorization

For each discovered actuator, the mobile device (100) may request authorization to the control server (200). The system may utilize room-level localization or (the) perception-aware influence detection depending on the actuator's type. For example, BLE RSSI-based thresholding may be used as an approximation of room-level localization, and additionally, audio-based influence detection, for IoT speakers.

For the audio-based influence-aware authorization, the control server (200) may capture source audio signal that the speaker is playing. To circumvent a case of unavailable audio sources (e.g., where the audio source is not extractable and cannot be used) and mitigate distortion issues, actual source signal of the speaker may be equipped with a microphone device (e.g., Raspberry Pi) which samples actual source signal from the speaker.

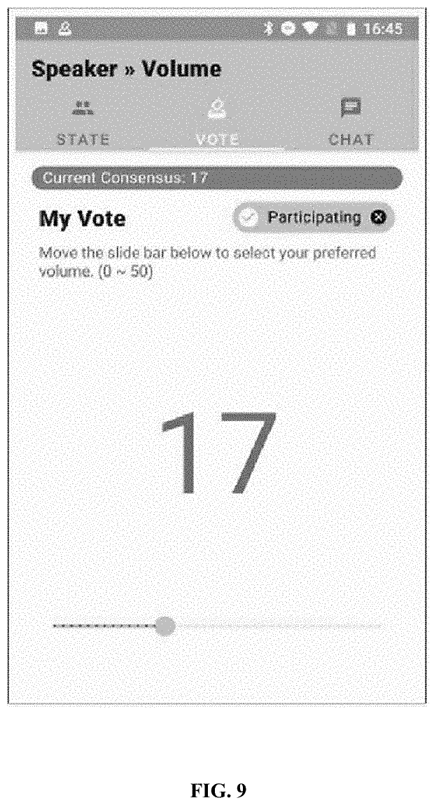

FIG. 7, FIG. 8, and FIG. 9 show execution screens or display (e.g., screenshots) of an application (app) of the mobile apparatus or device (100) of FIG. 4, according to various embodiments.

FIG. 7 shows a list of actuators in the execution screen of the app of the mobile device (100). In FIG. 7, the screen indicates “Mood Lamp” actuator with “Lighting Effect” as a controllable state item for the “Mood Lamp” actuator, and currently 2 participants. Also, the screen indicates “Diffuser” actuator with “ON/OFF” switch as a controllable state item, and currently 3 participants. Also, the screen indicates “Speaker” actuator with “Volume” level as a controllable state item.

FIG. 8 shows a user interface for an aggregate result among the execution screens of the app of the mobile device (100). In FIG. 8, the screen indicates “Speaker” as the actuator and “Playlist” as the controllable state (STATE). The “Current Consensus” is “Sunny Beats,” and “Preference Distribution” is 1 vote for “Relaxing Chopin,” 2 votes for “Piano Ballads,” 1 vote for “Winter Acoustic,” and 2 votes for “Relax & Unwind”; the current user “You” is shown to have voted for “Piano Ballads.”

FIG. 9 shows a voting (VOTE) user interface among the execution screens of the app of the mobile device (100). In FIG. 9, the screen indicates “Speaker” as the actuator and “Volume” level as a controllable state item. The volume can be entered in the range of 0 and 50, and the “Current Consensus” is “7.” The screen shows the current user of the app wanting to vote “17.” The “Volume” may be controlled via a slide-type user interface.

According to the present embodiment(s), a plurality of visitors may appropriately operate an actuator in a common space. By supporting and allowing visitors to instantly engage in democratic, collective control practices, actuators that are exclusively controlled exclusively in public or common spaces may be converted to truly public or common actuators.

In addition, many ready-made and other actuators may be easily integrated without modifying (the) implementation methods.

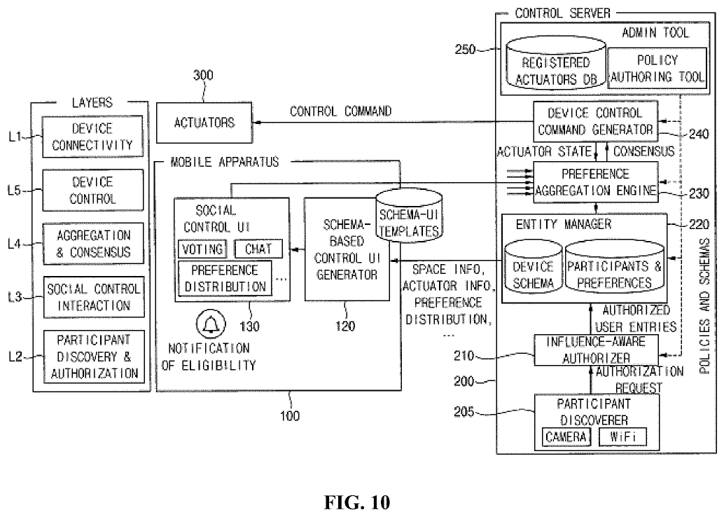

FIG. 10 shows a detailed block diagram of a system of social control-and-use of IoT device, according to an(other) embodiment.

The present embodiment is substantially the same as the embodiment(s) described with reference to FIG. 1 through FIG. 9, except for the operation and configuration of the participant discovery and authorization layer (L2), and the same reference numerals are used for the same or analogous elements or components, and duplicate descriptions are omitted.

The system may comprise the visitor's mobile apparatus or device (100), control server (200), and public or common actuator (300). The system may further comprise auxiliary or support apparatus or device for discovery and authorization.

The control server (200) may perform authorization as to the mobile device (100), and generate and output user interface for voting to the mobile device (100). The mobile device (100) may output a voting value which indicates the participant's preference to the control server (200). The control server (200) may derive consensus based on the voting value(s) received from a plurality of user's mobile device (100), and generate a control signal based on the consensus, and output the control signal to the common actuator (300). The participants' preferences may be reflected to control the common actuator (300).

The mobile device (100) may comprise a schema-based control user interface (UI) generator (120) and a social control user interface (UI) (130). The mobile device (100) may perform operation(s) of the schema-based control UI generator 120 and the social control UI (130).

The control server (200) may comprise a participant discoverer (205), influence-based or influence-aware authorizer (210), entity manager (220), preference aggregation engine (230), device control command generator (240), and admin tool (250). The entity manager (220) may manage device schema, participants and preferences. The management tool (250) may comprise a registered actuators database and policy authoring tools.

In FIG. 5, it was described that the device discoverer (110) of the mobile apparatus or device (100) detects a beacon and informs that the visitor may be within an area of influence (AoI) of the actuator and the app of the mobile device (100) invokes the influence-aware authorizer (210).

Differently, in the present embodiment, the participant discoverer (205) of the control server (200) may directly search, discover and authorize the mobile device (100) within the area of influence (AoI) of the actuator.

For example, when entering a common space or when facing confronting instantiated actuator (300) in the system, the user may automatically receive a notification or alarm as to (potential) eligibility for participation in control of the actuator (300) through the mobile device (100).

According to the present disclosure, a plurality of visitors may appropriately control actuators in a common space; by supporting to allow visitors to instantly engage in democratic, collective control methods, actuators which are exclusively controlled in common spaces may be converted to truly common-use actuators.

Also, numerous ready-made and other actuators may be integrated without modifying (the) implementation methods.

The present disclosure relates to a system and method of social control-and-use of IoT device, a control server supporting social control-and-use of IoT device, and a mobile device used for social control-and-use of IoT device, which allow a plurality of visitors to control actuators in public, shared, or common spaces.

Exemplary embodiments have been described in detail with references to the accompanying drawings, for illustrative purposes. Although the description above contains much specificity, these should not be construed as limiting the scope of the exemplary embodiments. The exemplary embodiments may be modified and implemented in various forms and should not be interpreted as thus limited. A person skilled in the art will understand that various modifications and alterations may be made without departing from the spirit and scope of the description and that such modifications and alterations are within the scope of the accompanying claims.

What is claimed is:

1. A system of social control and use of Internet-of-Things device, comprising:
an actuator arranged or disposed in a public or common space;
one or more mobile devices, comprising a social control user interface, which includes a voting function; and
a control server, comprising
a preference aggregation engine, deriving a consensus by aggregating vote values from the one or more mobile devices, and
a device control command generation unit, generating a device control command based on the consensus.

2. The system of social control and use of Internet-of-Things device of claim 1, wherein
the control server further comprises an entity manager unit for managing the Internet-of-Things device operated by the actuator, the common space, and one or more participants.

3. The system of social control and use of Internet-of-Things device of claim 2, wherein
the entity manager outputs information of the common space, information of the Internet of Things device, and information of preference distribution of the one or more participants to the one or more mobile devices; and
the one or more mobile devices further comprises a schema-based control user interface generation unit, generating the social control user interface based on the information of the common space, the information of the Internet of Things device, and the information of the preference distribution of the participants.

4. The system of social control and use of Internet-of-Things device of claim 1, wherein
the one or more mobile devices further comprises a device discovery unit, using a distance measuring technology, including at least one of Bluetooth, BLE (Bluetooth Low Energy), Wi-Fi, UWB (Ultra-Wideband), LIDAR (light detection and ranging), and SONAR (sound navigation and ranging), and notifying that a visitor exists or not exist within an area of influence of the actuator; and
the control server further comprises an influence-aware-based authorization unit, determining whether the visitor is the participant based on influence of the Internet-of-Things device, and granting authority for the social control and use of the Internet-of-Things device to the participant.

5. The system of social control and use of Internet-of-Things device of claim 4, wherein
the influence-aware-based authorization unit determines the area of influence of the actuator through a room-level indoor positioning technology based on space division or layout of the common space.

6. The system of social control and use of Internet-of-Things device of claim 4, wherein
the influence-aware-based authorization unit receives signal of the actuator through the one or more devices and determines whether the one or more devices is within the area of influence of the actuator.

7. The system of social control and use of Internet-of-Things device of claim 6, wherein
when the actuator is a speaker,
the one or more mobile devices records audio in surrounding environment, and extracts a first audio feature, and transmits the first audio feature to the control server; and
the influence-aware-based authorization unit of the control server extracts a second audio feature from source audio, and calculates a temporal correlation distance between the first audio feature and the second audio feature, and determines whether the one or more devices is within the area of influence of the actuator based on the temporal correlation distance.

8. The system of social control and use of Internet-of-Things device of claim 7, wherein
the influence-aware-based authorization unit synchronizes time offset of the first audio feature and the second audio feature.

9. The system of social control and use of Internet-of-Things device of claim 8, wherein
the influence-aware-based authorization unit filters the temporal correlation distance with signal strength of the source audio.

10. The system of social control and use of Internet-of-Things device of claim 4, wherein
the control server further comprises an administration tool,
the administration tool, comprising a policy authoring tool,
the policy authoring tool, setting aggregation policy and authorization policy, and outputting the aggregation policy to a preference aggregation engine and outputting the authorization policy to the influence-aware-based authorization unit.

11. The system of social control and use of Internet-of-Things device of claim 1, wherein
the preference aggregation engine uses a utility function,
the utility function, receiving a user preference for a state of the actuator as input and returning quantified satisfaction between 0 (“unhappy”) and 1 (“happy”).

12. The system of social control and use of Internet-of-Things device of claim 11, wherein when variables of the actuator has nominal scale,
the utility function is
$$U ( {p}_{i} , s ) = \{ \begin{matrix}1. & if s ∈ {p}_{i} \\ 0. & if s ∉ {p}_{i}\end{matrix} \begin{matrix}U : utility function \\ {p}_{i} : selected options \\ s : state of an actuator\end{matrix}$$
and pi is option selected by a participant i, and s is the state of the actuator.

13. The system of social control and use of Internet-of-Things device of claim 11, wherein when the variables of the actuator have ordinal scale,
the satisfaction degrades when a distance between the state of the actuator and the user preference increases.

14. The system of social control and use of Internet-of-Things device of claim 1, wherein
the preference aggregation engine determines a state of the actuator as the state which maximizes total utility of the one or more participants in a first mode.

15. The system of social control and use of Internet-of-Things device of claim 14, wherein in the first mode, a next state of the actuator is determined by formula
$${s}_{next} = {arg max}_{s ∈ S} \vert {\sum }_{i ∈ I} U ( {p}_{i} , s ) \vert \begin{matrix}I : set of participants \\ {s}_{next} : next actuator state \\ S : set of state variable options\end{matrix}$$
and I is a set of the participants, snext is the next state of the actuator, and S is a set of variable options of the state of the actuator; U is a utility function, pi is option selected by the participant i and s is the state of the actuator.

16. The system of social control and use of Internet-of-Things device of claim 1, wherein
the preference aggregation engine determines a state of the actuator by distributing utility over time in a second mode and allowing the participants to receive the utility in turn.

17. The system of social control and use of Internet-of-Things device of claim 16, wherein in the second mode, a next state of the actuator is determined as the state in which a sum of past cumulative satisfaction and future expected satisfaction is maximum for the participant having a minimum sum of the cumulative past satisfaction and the estimated future satisfaction.

18. The system of social control and use of Internet-of-Things device of claim 17, wherein in the second mode, the next state of the actuator is determined by formulas
$${U}_{prev} = {\sum }_{t = τ - ω}^{τ - 1} U ( {p}_{i , t} , {s}_{t} ) , {U}_{exp} = {\sum }_{t = τ}^{τ + δ ( s )} U ( {p}_{i , t} , s ) \\ {s}_{next} = {arg max}_{s ∈ S} {min}_{i ∈ t} [ {U}_{prev} + {U}_{exp} ]$$
and Uprev is the past cumulative satisfaction, Uₑₓₚ is future estimated satisfaction; τ is current time; ω is time window for calculating the past cumulative satisfaction, δ(s) is expected duration that the state s holds or is expected to continue in the future; pi,t is option selected at time t by participant i; and st is state of the actuator at the time t.

19. The system of social control and use of Internet-of-Things device of claim 1, wherein
the preference aggregation engine configured to apply state priority to a particular state among a plurality of states in a third mode.

20. The system of social control and use of Internet-of-Things device of claim 19, wherein in the third mode, the preference aggregation engine is configured to prevent oscillations by temporarily assigning high priority to a current state of the actuator.

21. The system of social control and use of Internet-of-Things device of claim 19, wherein in the third mode, the preference aggregation engine determines the state of the actuator based on priority among states specified by a manger of the common space.

22. The system of social control and use of Internet-of-Things device of claim 1, wherein
the preference aggregation engine determines a state of the actuator that maximizes total of utility of participants, in a first mode;
the preference aggregation engine determines the state of the actuator by distributing the utility over time in a second mode to allow the participants to receive the utility in turn, in a second mode;
the preference aggregation engine determines the state of the actuator by applying state priority to a particular state among a plurality of states, in a third mode; and
the preference aggregation engine applies the first mode, the second mode, and the third mode sequentially according to predetermined mode priority.

23. The system of social control and use of Internet-of-Things device of claim 1, wherein
the preference aggregation engine determines a state of the actuator that maximizes total of utility of participants, in a first mode;
the preference aggregation engine determines the state of the actuator by distributing the utility over time in a second mode to allow the participants to receive the utility in turn, in a second mode;
the preference aggregation engine determines the state of the actuator by applying state priority to a particular state among a plurality of states, in a third mode; and
the preference aggregation determines state of the actuator based on a weighted sum of the first mode, the second mode, and the third mode.

24. The system of social control and use of Internet-of-Things device of claim 1, wherein
the control server further comprises a participant discovery unit, searching for the one or more mobile devices of visitors within an area of influence of the actuator; and
an influence-aware-based authorization unit, determining whether the visitor are participant based on physical states of the visitors and the area of influence of the Internet-of-Things device, and granting authority to the social control and use of the Internet-of-Things device to the participants.

25. The method of social control and use of Internet-of-Things device, comprising
transmitting to a control server, a voted value based on a social control user interface included in one or more mobile devices;
aggregating in the control server, the voted values from the one or more mobile devices and deriving a consensus on operation of an actuator located in a common space;
generating device control command based on the consensus; and
outputting the device control command to the actuator.

26. The method of social control and use of Internet-of-Things device of claim 25, wherein in a device connectivity layer, connection between/among the one or more mobile devices, control server, and the actuator is provided.

27. The method of social control and use of Internet-of-Things device of claim 26, wherein in a participant discovery and authorization layer, participants near the common space are identified, and authority of the social control and use of the Internet-of-Things device granted to the participants.

28. The method of social control and use of Internet-of-Things device of claim 27, wherein in a social interaction layer, a social control user interface is provided in the one or more mobile devices of the participants granted authority, and the voted value from the social control user interface is received.

29. The method of social control and use of Internet-of-Things device of claim 28, wherein in an aggregation and consensus layer, a plurality of preferences collected from the participants in the social control interaction layer, is collected, and the consensus is derived on the plurality of the preferences.

30. The method of social control and use of Internet-of-Things device of claim 29, wherein in the aggregation and consensus layer, control of the Internet-of-Things device is performed based on the consensus derived.

31. The method of social control and use of Internet-of-Things device of claim 27, wherein in the participant discovery and authentication layer, the authority of the social control and use of the Internet-of-Things device is granted to the one or more mobile devices of the participants within an area of influence of the actuator, among the participants near the common space.

32. The method of social control and use of Internet-of-Things device of claim 31, wherein in the participant discovery and authentication layer, the authority of the social control and use is updated in real-time when the participants within the area of influence of the actuator move out of the area of influence, or whether a new participant moves into the area of influence of the actuator.

33. The method of social control and use of Internet-of-Things device of claim 32, wherein, when the authority of the social control and use is updated in the participant discovery and authentication layer, in the social control interaction layer, the social control user interface is provided to the mobile device of the changed participant in real time, and in the aggregation and consensus layer, the consensus on updated preference is derived.

34. A control server system supporting social control and use of Internet-of-Things device, comprising:
an influence-based authorizer, determining whether one or more visitors is a participant based on physical state of the visitor in a common space and area of influence of the Internet-of-Things device, and granting the participant authority to control and use the Internet-of-Things device;
an entity manager, managing the Internet-of-Things device, the common space, and the participant;
a preference aggregation engine, deriving a consensus by aggregating voted values from the participant's mobile device; and
a device control command generator, generating a device control command based on the consensus.

35. A mobile device used for social control and use of Internet-of-Things device, comprising:
a device discovery unit, notifying a control server of proximity to an actuator in a common space;
a schema-based control user interface generation unit, generating a social control user interface based on information of the common space and Internet-of-Things device received from the control server; and
a social control user interface, including a voting function for voting a preference for controlling the actuator.
